(19) United States
(12) Patent Application Publication
(10) Pub. No.: US 2013/0167810 A1
(43) Pub. Date: Jul. 4, 2013

(54) SYSTEM AND METHOD FOR CONTROLLING PRESSURE RATIO OF A COMPRESSOR

(71) Applicants: Jayant K. Roplekar, Peoria, IL (US); Travis E. Barnes, Metamora, IL (US); Nathan P. Atterberry, Washington, IL (US); Keith N. E. Troisi, Washington, IL (US)

(72) Inventors: Jayant K. Roplekar, Peoria, IL (US); Travis E. Barnes, Metamora, IL (US); Nathan P. Atterberry, Washington, IL (US); Keith N. E. Troisi, Washington, IL (US)

(73) Assignee: Caterpillar Inc.

(21) Appl. No.: 13/338,783

(22) Filed: Dec. 28, 2011

(51) Int. Cl. F02B 33/00

(52) U.S. Cl. 123/564

(57) ABSTRACT

A system for controlling a pressure ratio of an output pressure to an input pressure of a compressor associated with an engine is disclosed. The system includes a controller configured to receive signals indicative of an input pressure associated with a compressor, and receive signals indicative of an output pressure associated with the compressor. The controller is further configured to compare a compressor pressure ratio of the output pressure to the input pressure with a threshold pressure ratio, and control a bypass valve in flow communication with the compressor based on the comparison.

### TECHNICAL FIELD

The present disclosure relates to a system and method for controlling a pressure ratio of a compressor and, more particularly, to a system and method for controlling a pressure ratio of an output pressure and an input pressure of a compressor.

### BACKGROUND

Some machines include an internal combustion engine for supplying power to the machine that may be used to propel the machine and operate devices associated with the machine. In order to increase power output of the internal combustion engine, some machines may include a compressor configured to increase the pressure of air supplied for combustion in the engine. Such a compressor is provided downstream of an inlet for air entering the intake system of the engine from the surroundings and increases the pressure of the air prior to being directed into the combustion chambers of the engine via the intake system.

During operation of an internal combustion engine including a compressor, operational conditions may occur that result in undesirable compressor surge. During a typical compressor surge event, air that would normally be flowing from the compressor to the combustion chambers reverses flow and creates a pressure spike at the compressor. Such an event may occur, for example, when an engine operating at high speed or load is suddenly operated at a low speed or load. As the engine transitions from the high speed to the low speed, the amount of air used for combustion dramatically decreases, yet the compressor continues to increase the pressure of the intake air due, for example, to inertia. As a result, pressure between the compressor and the combustion chambers may momentarily spike. Such a pressure spike or surge may result in undesirable noise and may possibly reduce the service life of components associated with the compressor. As a result, it may be desirable to provide a system and method for mitigating or preventing pressure surge associated with operation of the compressor.

One attempt to control compressor surge is described in U.S. Pat. No. 6,213,724 B1 to Haugen et al. (“the '724 patent”). The '724 patent discloses a method for controlling working fluid surge in a centrifugal compressor. According to the method disclosed in the '724 patent, surge detection is accomplished by calculating the change in the compressible fluid mass flow rate that accompanies surge in the compressor. The compressor includes means for sensing a first fluid temperature, means for sensing a first pressure, means for sensing a second pressure, and means for measuring current drawn by a compressor prime mover. The method disclosed in the '724 patent includes the steps of calculating the time rate of change of the first fluid temperature, the first fluid pressure, the second fluid pressure, and current drawn by the compressor prime mover. The method further includes calculating the mass flow rate by combining the calculated rates of change, and comparing the calculated mass flow rate to a predetermined acceptable mass flow rate to determine if surge is present.

Although the method disclosed in the '724 patent may determine whether compressor surge is present, it may suffer from a number of possible drawbacks. For example, the method may not reliably mitigate or prevent compressor surge. The systems and methods disclosed herein may be directed to mitigating or overcoming the possible drawback set forth above.

### SUMMARY

In one aspect, the present disclosure includes a system for controlling a pressure ratio of an output pressure to an input pressure of a compressor associated with an engine. The system includes a controller configured to receive signals indicative of an input pressure associated with a compressor, and receive signals indicative of an output pressure associated with the compressor. The controller is further configured to compare a compressor pressure ratio of the output pressure to the input pressure with a threshold pressure ratio, and control a bypass valve in flow communication with the compressor based on the comparison.

In another aspect, the present disclosure includes a method for controlling a pressure ratio of an output pressure to an input pressure of a compressor associated with an engine. The method includes receiving signals indicative of an input pressure associated with a compressor, and receiving signals indicative of an output pressure associated with the compressor. The method further includes comparing a compressor pressure ratio of the output pressure to the input pressure with a threshold pressure ratio, and controlling a bypass valve in flow communication with the compressor based on the comparison.

In still a further aspect, a machine includes an engine and an intake system associated with the engine. The intake system includes a compressor configured to increase pressure of air supplied to the engine, and a bypass valve configured to divert air supplied to the engine from the intake system. The machine further includes an exhaust system configured to provide flow communication from the engine to the surroundings, and a controller. The controller is configured to receive signals indicative of an input pressure associated with the compressor and signals indicative of an output pressure associated with the compressor. The controller is further configured to compare a compressor pressure ratio of the output pressure to the input pressure associated with the compressor with a threshold pressure ratio, and control the bypass valve based on the comparison.

### BRIEF DESCRIPTION OF THE DRAWINGS

FIG. 1 is a side view of an exemplary embodiment of a machine.

FIG. 2 is a schematic diagram of an exemplary embodiment of an engine and associated components.

FIG. 3 is a control diagram of an exemplary method for controlling the pressure ratio of a compressor.

### DETAILED DESCRIPTION

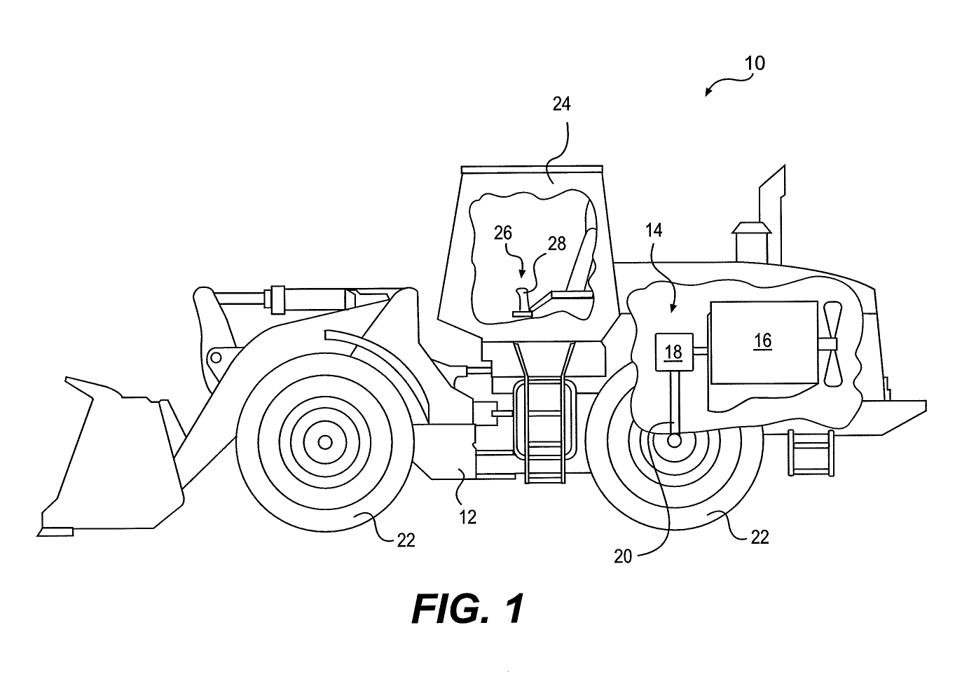

FIG. 1 schematically illustrates an exemplary embodiment of a machine 10. Exemplary machine 10 includes a chassis 12 and a power train 14 coupled to chassis 12. Power train 14 includes an internal combustion engine 16, a transmission 18, and a final drive 20 configured to provide power to traction devices 22 configured to propel machine 10. Exemplary machine 10 further includes an operator station 24 provided with an operator interface 26, including one or more control devices 28 configured to permit an operator to control operation of machine 10. For example, operator interface 26 may include a control device 28 configured to control the speed and/or direction of travel of machine 10. FIG. 1 schematically depicts an exemplary control device 28 including a single lever, but control device 28 may be any device or devices for use by an operator, either directly or remotely, for controlling the speed, travel path, and/or power output (e.g., throttle) of machine 10, such as, for example, one or more joy-sticks, one or more hand-operated or foot-operated levers, and/or a steering wheel.

Exemplary machine 10 shown in FIG. 1 is a wheel loader. However, machine 10 may be any type of ground-borne vehicle, such as, for example, an automobile, a truck, an agricultural vehicle, and/or a construction vehicle, such as, for example, a dozer, a track-type tractor, an excavator, a grader, an on-highway truck, an off-highway truck, and/or any other vehicle type known to a person skilled in the art. In addition, machine 10 may be any stationary machine, such as, for example, genset for generating electric power or a pump for pumping a fluid such as water, natural gas, or petroleum. Engine 16 may be any device that generates power, such as, for example, an internal combustion engine, including but not limited to spark-ignition engines, compression-ignition engines, rotary engines, gas turbine engines, and/or engines powered by gasoline, diesel fuel, bio-diesel, ethanol, methanol, and combinations thereof. Machine may further include other sources of power, such as, for example, hydrogen-powered engines, fuel cells, solar cells, and/or any other power source known to a person skilled in the art. Further, traction devices 22 may include wheels, tracks, belts, tires, and/or any other device(s) for propelling a machine known to a person skilled in the art.

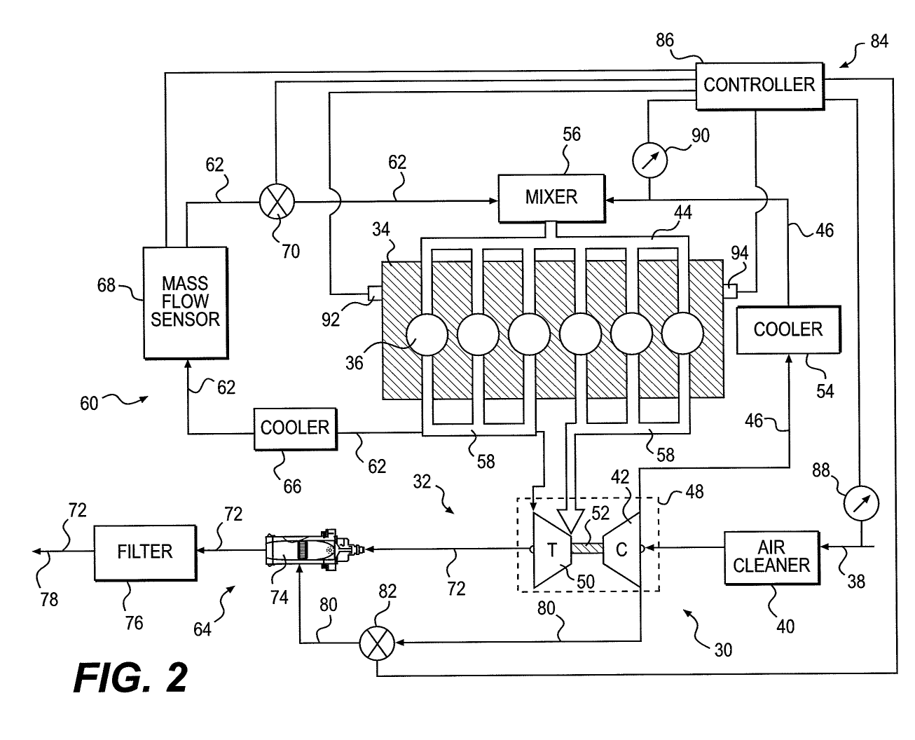

As shown in FIG. 2, exemplary machine 10 includes engine 16, an intake system 30, and an exhaust system 32. Exemplary engine 16 includes a cylinder block 34 at least partially defining a plurality of cylinders 36 providing combustion chambers in which an air-fuel mixture is combusted to generate power. Although exemplary engine 16 shown in FIG. 2 includes six cylinders 36 in an in-line configuration, engines having other numbers of cylinders and other configurations known in the art are contemplated.

Exemplary intake system 30 shown in FIG. 2 is configured to provide air to cylinders 36 from an intake inlet 38 that provides flow communication between ambient air of the surroundings and cylinders 36. Intake system 30 includes an air cleaner 40 configured to remove particulate matter from air entering intake inlet 38 from the surroundings and may include a filter device as known in the art. Exemplary intake system 30 also includes a compressor 42 configured to increase the pressure of air entering intake system 30 at intake inlet 38 before it reaches an intake manifold 44 providing flow communication with cylinders 36 via intake conduit 46. Exemplary compressor 42 shown in FIG. 2 is a part of a turbocharger 48 further including an exhaust-driven turbine 50. Turbine 50 is coupled via a shaft 52 to compressor 42, such that flow of exhaust gas through turbine 50 results in turbine 50 rotating shaft 52, which, in turn, drives compressor 42, thereby increasing the pressure of air in intake system 30. Although exemplary compressor 42 is a turbine-driven compressor, other types of compressors are contemplated, such as, for example, compressors driven by an output shaft of engine 16 and/or other motors.

Exemplary intake system 30 also includes an air cooler 54 configured to cool compressed air downstream of compressor 42 before the compressed air enters intake manifold 44, resulting in a cooler air-fuel mixture. Cooler 54 may be any type of cooler known in the art, such as, for example, an air-cooled air cooler or a liquid-cooled air cooler. Exemplary intake system 30 also includes a mixer 56 configured to combine a portion of exhaust gas re-circulated for addition to air entering exhaust manifold 44.

Exemplary exhaust system 32 is configured to provide flow communication between cylinders 36 and the ambient air of the surroundings, so that by-products of combustion in cylinders 36 can be treated and expelled to the surroundings. Exemplary exhaust system 32 shown in FIG. 2 includes an exhaust manifold 58 providing flow communication between cylinders 36 and either an exhaust gas recirculation system 60 via recirculation conduit 62 providing flow communication with mixer 56 and intake system 30, or an exhaust gas treatment system 64.

Exemplary exhaust gas recirculation system 60 is configured to permit a controlled amount of exhaust gas to be supplied to intake system 32 via mixer 56. As shown in FIG. 2, exemplary exhaust gas recirculation system 60 includes a cooler 66 downstream of exhaust manifold 58 and upstream of a mass flow sensor 68. Exemplary cooler 66 is configured to cool exhaust gas before it reaches mixer 56, which may provide benefits to the combustion process ofengine 16. Cooler 66 may be any type of cooler known in the art, such as, for example, an air-cooled cooler or a liquid-cooled cooler. Mass flow sensor 68 is configured to provide signals indicative of the flow rate of exhaust gas through conduit 60 to mixer 56. Exhaust gas recirculation system 60 may further include a valve 70 configured to control the flow of exhaust gas from exhaust manifold 58 to mixer 56.

As shown in FIG. 2, exhaust gas treatment system 64 is downstream of turbine 50 of turbocharger 48 and may be configured to remove undesirable particulates from the exhaust gas and/or convert undesirable exhaust gas constituents to more desirable exhaust gas constituents, as is known in the art. Exemplary exhaust gas treatment system 64 includes an exhaust conduit 72 providing flow communication with a regeneration device 74 located downstream of turbine 50 and upstream of a particulate filter 76 (e.g., a diesel particulate filter), which, in turn, is upstream of exhaust outlet 78. Exemplary particulate filter 76 may be configured to trap undesirable particulates, so that they do not exit exhaust outlet 78, as is known in the art. Because the effectiveness of particulate filter 76 may degrade as more particulates are trapped therein, it may be desirable to regenerate the effectiveness of particulate filter 76. Exemplary regeneration device 74 may be configured to regenerate particulate filter 76 according to methods known in the art. For example, according to some embodiments, regeneration device 74 may be configured to ignite and burn-off particulates accumulated in particulate filter 76 to enhance the effectiveness of particulate filter 76.

As shown in FIG. 2, exemplary exhaust gas treatment system 64 may further include a bypass conduit 80 providing flow communication between compressor 42 and regeneration device 74. In the exemplary embodiment shown, a bypass valve 82 may be located between compressor 42 and regeneration device 74 to control flow communication therebetween. Bypass valve 82 may be located at other locations intake system 30, such as any location between compressor 42 and cylinders 36. According to some embodiments, bypass valve 82 may be opened to supply air to regeneration device 74, thereby supplying air for ignition and combustion of particulates in particulate filter 76. In addition, as explained in more detail below, bypass valve 82 may be configured to bleed pressure created by operation of compressor 42, for example, to reduce the pressure ratio of the output pressure to the input pressure of compressor 42. According to some embodiments, pressure may be bled to the surroundings and/or to a location of intake system 30 upstream from compressor 42.

As shown in FIG. 2, exemplary machine 10 also includes a control system 84 configured to control operation of engine 16, intake system 30, and/or exhaust system 32. For example, exemplary control system 84 shown in FIG. 2 includes a controller 86, a sensor 88 configured to provide signals indicative of the pressure at intake inlet 38 to controller 86, and a sensor 90 configured to provide signals indicative of the pressure downstream of compressor 42, for example, at a location upstream of intake manifold 44. According to some embodiments, sensor 88 may be located between air cleaner 40 and compressor 42. Exemplary controller 86 is configured to receive signals indicative of pressure from sensors 88 and 90 and calculate a pressure ratio indicative of the output pressure to the input pressure of compressor 42 based on respective signals received from sensor 90 and sensor 88.

Exemplary control system 84 may also include a sensor 92 configured to provide signals indicative of the speed of engine 16 and a sensor 94 configured to provide signals indicative of the fuel (e.g., mass, volume, and/or rate) supplied to engine 16. Alternatively, or in addition, control system 84 may include an engine control module (not shown) that may provide signals indicative of engine speed and/or the fuel supplied to engine 16. Such an engine control module may be separate from or integral with controller 86.

Exemplary controller 86 may include one or more processors, microprocessors, central processing units, on-board computers, electronic control modules, and/or any other computing and control devices known to those skilled in the art. Controller 86 may be configured run one or more software programs or applications stored in a memory location, read from a computer-readable medium, and/or accessed from an external device operatively coupled to controller 86 by any suitable communications network.

Exemplary controller 86 may be configured to control the pressure ratio of compressor 42. For example, controller 86 may be configured to control a ratio of the output pressure to the input pressure of compressor 42. This may result in mitigating or preventing compressor surge associated with operation of compressor 42. In particular, compressor 42 is configured to increase the pressure of ambient air supplied via air inlet 38 from the surroundings of machine 10, and increase the pressure of the air prior to the air being supplied via intake system 30 to cylinders 36 for combustion. Under certain operating conditions, pressure on the downstream side of compressor 42 may quickly increase, creating a surge in back-pressure in intake system 30. This may occur when, for example, engine 16 quickly transitions from a high speed or load to a low speed or load. For example, during the high speed condition, compressor 42 may be operating at a high speed to increase the pressure in intake system 30. However, if the speed of engine 16 is suddenly reduced, the air supplied by compressor 42 may become higher than consumed by engine 16 at low speed. As a result, compressor 42, which may continue to operate at a high rate or speed due, for example, to inertia, is exposed to a sudden increase in pressure or surge. Such occurrences may create undesirable noise and/or reduce the service life of compressor 42 and parts associated therewith.

### INDUSTRIAL APPLICABILITY

The disclosed system and method for controlling a pressure ratio of a compressor may be used with any machine having an engine supplied with intake air via a compressor. The disclosed system and method may result in improved operation of a machine. For example, control system 84 may be configured control the pressure ratio of the output pressure to the input pressure of compressor 42, and thereby mitigate or prevent pressure surge associated with compressor 42. For example, controller 86 may be configured to receive signals indicative of an input pressure from sensor 88 and an output pressure from sensor 90 and control bypass valve 82, for example, in a closed-loop feedback manner, so that the pressure ratio at compressor 42 may be controlled.

According to some embodiments, controller 86 is configured to receive signals indicative of the speed of engine 16 and the fuel (e.g., mass, volume, and/or rate) supplied to engine 16 and determine a threshold pressure ratio. The fuel supplied to engine 16 may be based on, for example, fuel mass, fuel volume, and/or fuel mass/volume supplied per injection or per unit time. Controller 86 may be configured to compare the pressure ratio (i.e., the actual pressure ratio) of compressor 42 based on signals from sensors 88 and 90 with the threshold pressure ratio and open bypass valve 82, so that pressure in intake system 30 is siphoned-off, for example, to exhaust system 32 via bypass conduit 80. According to some embodiments, controller 86 may be configured to determine the difference between the actual pressure ratio and the threshold pressure ratio and based on the difference, determine the cross-sectional area for opening bypass valve 82 sufficient to mitigate or prevent compressor surge. While this may result in mitigating or preventing pressure surge, it may also allow compressor 42 to remain responsive to a commanded increase in load on engine 16 following the release of pressure via bypass valve 82 by not opening bypass valve 82 a greater cross-sectional area, or for a longer duration, than sufficient to mitigate or prevent compressor surge. This may render engine 16 more responsive to an operator's commands following potential compressor surge conditions.

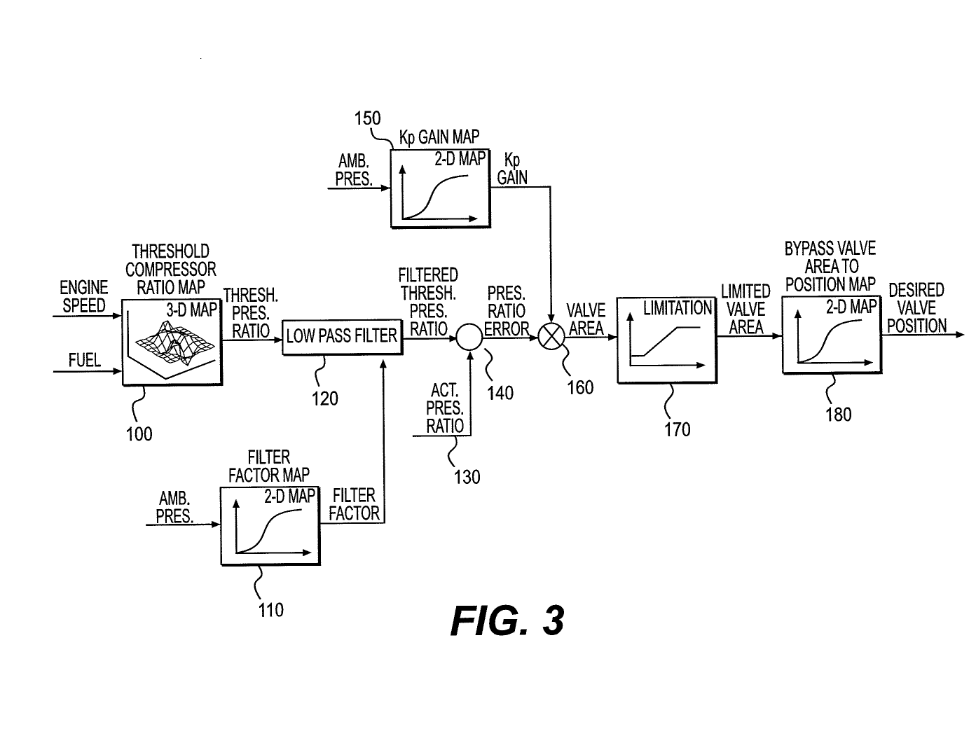

FIG. 3 shows a control diagram of an exemplary embodiment of a method of controlling the pressure ratio of compressor 42. At step 100, controller 86 receives signals indicative of the speed of engine 16 and the fuel supplied to engine 16. In the exemplary method shown, controller 16 uses the engine speed and fuel to determine a threshold pressure ratio. According to some embodiments, other parameters may be used to determine the threshold pressure ratio. The threshold pressure ratio corresponds to the maximum pressure ratio below which compressor 42 may operate without experiencing pressure surge based on the operating conditions of engine 16. The threshold pressure ratio may be based on information obtained from the manufacturer of the compressor, mathematical calculations, and/or experimentation. According to the exemplary embodiment shown, controller 86 may determine the threshold pressure ratio based on correlations between the threshold pressure ratio, engine speed, and fuel. Such correlations may take the form of three-dimensional maps, tables, and equations.

At step 110, controller 86 receives signals indicative of the ambient air pressure in the surroundings of machine 10 and using a filter factor correlation between a filter factor and ambient air pressure, determines a filter factor associated with a drop in intake pressure due to air cleaner 40. The signals may be received from, for example, sensor 88. The filter factor correlation may take the form of two-dimensional maps, tables, and equations.

At step 120, controller 86 is configured to use the threshold pressure ratio determined at step 100 and the filter factor determined at step 110 to determine a filtered threshold pressure ratio based on the ambient pressure. In the exemplary embodiment shown, controller 86 may use a low-pass filer to determine the filtered threshold pressure ratio.

At step 130, controller 86 determines the actual compressor pressure ratio of the output pressure to the input pressure of compressor 42 based on signals received from sensors 90 and 88, respectively. Thereafter, at step 140, the filtered threshold pressure ratio determined at step 120 is compared to the actual compressor pressure ratio determined at step 130. In particular, controller 86 determines the difference between the filtered threshold pressure ratio and the actual compressor pressure ratio to determine a pressure ratio error.

In the exemplary embodiment shown, at step 150, controller 86 determines a pressure gain Kₚ based on the ambient pressure of the surroundings of machine 86. For example, controller 86 uses correlations between pressure gain Kₚ and ambient pressure, which may take the form of two-dimensional maps, tables, and equations. According to some embodiments, parameters other than the ambient pressure may be used to determine a pressure gain.

At step 160, controller 86 multiplies the pressure ratio error by the pressure gain Kp to determine the cross-sectional area of the opening in bypass valve 82 sufficient to overcome the pressure ratio error. According to some embodiments, controller 86 may determine a current, position, and/or angle corresponding to the opening of bypass valve 82 rather than (or in addition to) the cross-sectional area. At step 170, controller 86 determines a limited cross-sectional area for opening bypass valve 82 based on correlations between other factors and a limited cross-sectional area of the bypass valve opening. These correlations may take the form of two-dimensional maps, tables, and equations.

At step 180, controller 86 determines a desired valve position based on the limited cross-sectional area determined at step 170. The desired valve position is determined based on correlations between the limited cross-sectional area and the valve position that provides the limited cross-sectional area. These correlations may take the form of two-dimensional maps, tables, and equations. Thereafter, controller 86 sends control signals to bypass valve 82 so that bypass valve 82 may be opened according to the desired valve position determined at step 180. In this exemplary manner, the pressure ratio of compressor 42 may be controlled, and compressor surge may be mitigated or prevented.

Although the exemplary control system disclosed above includes a proportional term, it is contemplated that the control system may include any combination of proportional terms, derivative terms, and integral terms as known in the art.

It will be apparent to those skilled in the art that various modifications and variations can be made to the exemplary disclosed systems, methods, and machine. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A system for controlling a pressure ratio of an output pressure to an input pressure of a compressor associated with an engine, the system comprising:
a controller configured to
receive signals indicative of an input pressure associated with a compressor;
receive signals indicative of an output pressure associated with the compressor;
compare a compressor pressure ratio of the output pressure to the input pressure with a threshold pressure ratio; and
control a bypass valve in flow communication with the compressor based on the comparison.

2. The system of claim 1, wherein the controller is configured to determine the threshold pressure ratio based on a speed of the engine and fuel supplied to the engine.

3. The system of claim 1, wherein the controller is configured to adjust the threshold pressure ratio based on ambient pressure.

4. The system of claim 1, wherein the controller is configured to subtract the compressor pressure ratio from the threshold pressure ratio to determine a pressure ratio error, and control the bypass valve based on the pressure ratio error.

5. The system of claim 4, wherein the controller is configured to control the bypass valve by sending signals indicative of a valve position to the bypass valve.

6. The system of claim 5, wherein the controller is configured to determine the valve position based on a cross-sectional area of an opening of the bypass valve corresponding to the pressure ratio error.

7. The system of claim 1, further including a bypass valve, wherein the bypass valve is configured to provide selective flow communication between the compressor and an exhaust system of the engine.

8. The system of claim 1, further including a bypass valve, wherein the bypass valve is configured to provide selective flow communication between the compressor and at least one of the surroundings and a location of an intake system of the engine upstream with respect to the compressor.

9. A method for controlling a pressure ratio of an output pressure to an input pressure of a compressor associated with an engine, the method comprising:
receiving signals indicative of an input pressure associated with a compressor;
receiving signals indicative of an output pressure associated with the compressor;
comparing a compressor pressure ratio of the output pressure to the input pressure with a threshold pressure ratio; and
controlling a bypass valve in flow communication with the compressor based on the comparison.

10. The method of claim 9, further including determining the threshold pressure ratio based on a speed of the engine and fuel supplied to the engine.

11. The method of claim 9, further including adjusting the threshold pressure ratio based on ambient pressure.

12. The method of claim 9, further including determining a pressure ratio error by subtracting the compressor pressure ratio from the threshold pressure ratio, and controlling the bypass valve based on the pressure ratio error.

13. The method of claim 12, wherein controlling the bypass valve includes controlling an amount of opening of the bypass valve based on the pressure ratio error.

14. The method of claim 13, wherein controlling the bypass valve includes sending signals indicative of a valve position to the bypass valve.

15. The method of claim 13, further including determining the valve position based on a cross-sectional area of an opening of the bypass valve corresponding to the pressure ratio error.

16. The method of claim 9, wherein controlling the bypass valve includes opening the valve so that air is diverted to at least one of an exhaust system of the engine, an intake system of the engine, and the surroundings.

17. A machine comprising:
an engine;
an intake system associated with the engine, the intake system including
a compressor configured to increase pressure of air supplied to the engine, and
a bypass valve configured to divert air supplied to the engine from the intake system;
an exhaust system configured to provide flow communication from the engine to the surroundings; and
a controller configured to
receive signals indicative of an input pressure associated with the compressor;
receive signals indicative of an output pressure associated with the compressor;
compare a compressor pressure ratio of the output pressure to the input pressure associated with the compressor with a threshold pressure ratio; and
control the bypass valve based on the comparison.

18. The machine of claim 17, wherein the bypass valve is configured to divert air from the intake system to at least one of an exhaust system of the engine, an intake system of the engine at a location upstream with respect to the compressor, and the surroundings.

19. The machine of claim 18, wherein the exhaust system includes a particulate filter regeneration device, and wherein the bypass valve is in flow communication with the particulate filter regeneration device.

20. The machine of claim 17, wherein the controller is configured to determine the threshold pressure ratio based on speed of the engine and fuel supplied to the engine.

21. The machine of claim 17, wherein the bypass valve is located between the compressor and cylinders of the engine.
